(19) United States
(12) Patent Application Publication
(10) Pub. No.: US 2010/0108232 A1
(43) Pub. Date: May 6, 2010

(54) METHOD FOR FABRICATING ELECTROWETTING DISPLAYS

(75) Inventors: Kuan-Ting Chen, Tainan County (TW); Wei-Yuan Cheng, Taipei County (TW); Kuo-Lung Lo, Taipei County (TW); Chih-Chun Hsiao, Hsinchu County (TW); Yu-Hsiang Tsai, Tainan County (TW)

Correspondence Address: QUINTERO LAW OFFICE, PC, 615 Hampton Dr, Suite A202, Venice, CA, 90291, US

(73) Assignee: INDUSTRIAL TECHNOLOGY RESEARCH INSTITUTE, Hsinchu (TW)

(21) Appl. No.: 12/540,280

(22) Filed: Aug. 12, 2009

Related U.S. Application Data
(60) Provisional application No. 61/111,614, filed on Nov. 5, 2008.

(51) Int. Cl. B32B 37/00

(52) U.S. Cl. 156/60

(57) ABSTRACT

A method for fabricating an electrowetting display is provided. The method includes forming a plurality of hydrophilic ribs on a first substrate, forming a retaining wall surrounding the hydrophilic ribs, filling a non-polar solution within the hydrophilic ribs, forming a polar solution over the non-polar solution and the hydrophilic ribs within the retaining wall, providing a second substrate and assembling the first substrate and the second substrate.

### CROSS-REFERENCE TO RELATED APPLICATIONS

This application claims the benefit of U.S. Provisional Application No. 61/111,614, filed Nov. 5, 2008, which is incorporated by reference herein in its entirety for any purpose.

### BACKGROUND OF THE INVENTION

1. Field of the Invention

The invention relates to a method for fabricating a display, and more particularly to a method for fabricating an electrowetting display.

2. Description of the Related Art

The first electrowetting display was developed by Robert A. Hayes and B. J. Feenstra in 2003. Its color transformation is achieved by applying various voltages to control the contact angle between oily medium and hydrophobic insulation layer. The display possesses a reflection index over 35% and a contrast index over 15, similar to paper (reflection index of 60% and contrast index of 15). Additionally, its operation voltage is less than 20V and response time is merely 12 ms (on-state) and 13 ms (of-state), respectively, with superior property. The electrowetting display is composed of a conductive liquid (water), a color oily medium, a hydrophobic insulation layer and transparent electrodes, having a simple fabrication. Compared to liquid crystal displays or electrophoresis displays, the electrowetting display possesses a potential for application in flexible display fabrication due to without an alignment process and microencapsulation.

However, due to simultaneous use of liquid mediums such as color oily medium and water medium, the electrowetting display should be assembled in water to seal such liquids thereinside.

### BRIEF SUMMARY OF THE INVENTION

One embodiment of the invention provides a method for fabricating an electrowetting display comprising forming a plurality of hydrophilic ribs on a first substrate, forming a retaining wall surrounding the hydrophilic ribs, filling a non-polar solution within the hydrophilic ribs, forming a polar solution over the non-polar solution and the hydrophilic ribs within the retaining wall, providing a second substrate and assembling the first substrate and the second substrate.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawing, wherein:

FIGS. 1A-1C show cross-sectional views of a method for fabricating an electrowetting display according to an embodiment of the invention.

FIGS. 2A-2C show cross-sectional views of a method for fabricating an electrowetting display according to an embodiment of the invention.

### DETAILED DESCRIPTION OF THE INVENTION

The following description is of the mode of carrying out the invention. This description is made for the purpose of illustrating the general principles of the invention and should not be taken in a limiting sense. The scope of the invention is determined by reference to the appended claims.

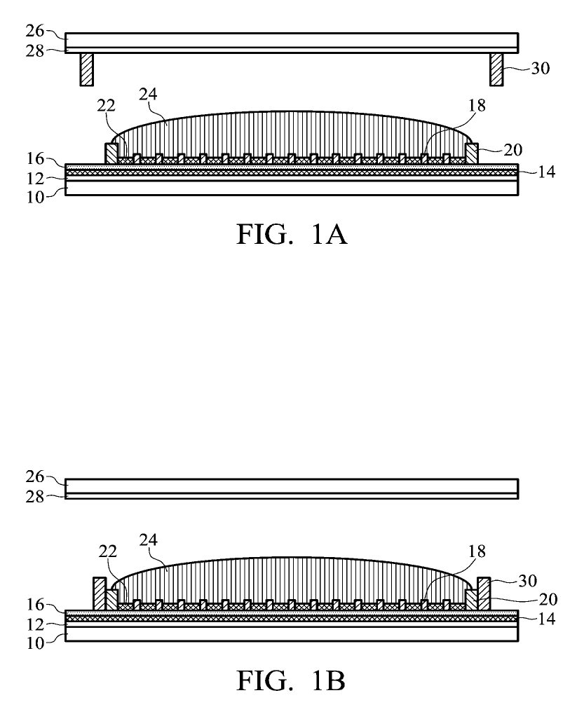

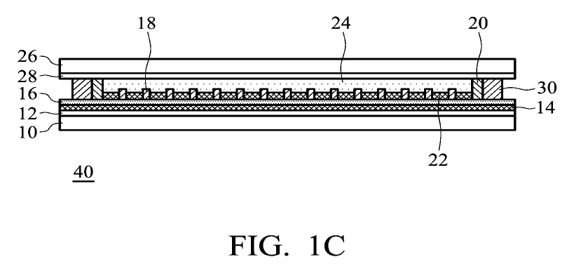

According to an embodiment of the invention, a method for fabricating an electrowetting display is shown in FIGS. 1A-1C.

Referring to FIG. 1A, a first substrate 10 is provided. The first substrate 10 may comprise glass, polymer materials or metal. A first electrode 12 is then formed on the first substrate 10. Next, a dielectric layer 14 is formed on the first electrode 12. The dielectric layer 14 may comprise silicon oxide, silicon nitride, tantalum oxide, lead zirconate titanate (PZT), barium strontium titanate (BST), barium titanate (BTO) or polyvinylidene difluoride (PVDF). A hydrophobic layer 16 is then formed on the dielectric layer 14. The hydrophobic layer 16 may comprise fluoro-containing or chloro-containing hydrophobic polymer materials or octadecyltrichlorosilane (OTS). Next, a plurality of hydrophilic ribs 18 are formed on the hydrophobic layer 16. The hydrophilic ribs 18 may comprise photoresist, thermosetting resin or photosetting resin. The hydrophilic ribs 18 are isolated from one another and each of them corresponds to a sub-pixel area. A retaining wall 20 is then formed to surround the hydrophilic ribs 18. The retaining wall 20 may comprise photoresist, thermosetting resin or photosetting resin. The retaining wall 20 may have at least one breach (not shown) of about 0.1 mm-5 mm. The retaining wall 20 may have a thickness of about 10 μm-100 μm. Next, a non-polar solution 22 is filled within the hydrophilic ribs 18 by, for example, inkjet printing, dip coating, slide coating, slot coating or blade coating. The non-polar solution 22 may comprise dye or pigment. A polar solution 24 is then formed over the non-polar solution 22 and the hydrophilic ribs 18 within the retaining wall 20 by, for example, inkjet printing, dip coating, slide coating, slot coating or blade coating. The polar solution 24 may comprise water, sodium chloride aqueous solution or potassium chloride aqueous solution. Next, a second substrate 26 is provided. The second substrate 26 may comprise glass, polymer materials or metal. A second electrode 28 is then formed on the second substrate 26. Next, a frame seal 30 is coated on the second electrode 28. The frame seal 30 may have at least one breach (not shown) of about 0.1 mm-5 mm. Optionally, the frame seal 30 is coated on the hydrophobic layer 16 over the first substrate 10, as shown in FIG. 1B. The first substrate 10 and the second substrate 26 are then assembled. After assembling, the frame seal 30 is cured. An electrowetting display 40 is then prepared, as shown in FIG. 1C. In FIG. 1C, the frame seal 30 is adjacent to the retaining wall 20. Optionally, the frame seal 30 is on the retaining wall 20 (not shown).

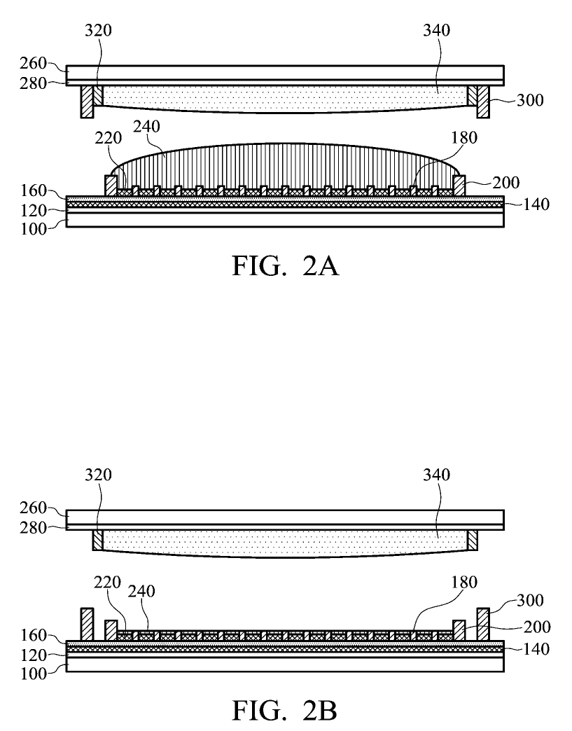

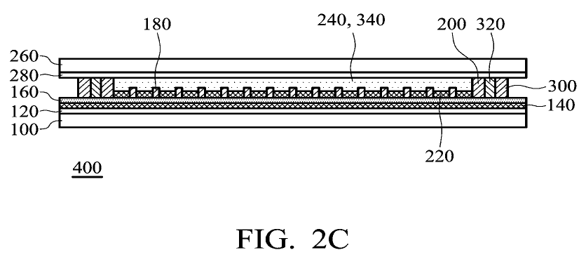

According to an embodiment of the invention, a method for fabricating an electrowetting display is shown in FIGS. 2A-2C.

Referring to FIG. 2A, a first substrate 100 is provided. The first substrate 100 may comprise glass, polymer materials or metal. A first electrode 120 is then formed on the first substrate 100. Next, a dielectric layer 140 is formed on the first electrode 120. The dielectric layer 140 may comprise silicon oxide, silicon nitride, tantalum oxide, lead zirconate titanate (PZT), barium strontium titanate (BST), barium titanate (BTO) or polyvinylidene difluoride (PVDF). A hydrophobic layer 160 is then formed on the dielectric layer 140. The hydrophobic layer 160 may comprise fluoro-containing or chloro-containing hydrophobic polymer materials or octadecyltrichlorosilane (OTS). Next, a plurality of hydrophilic ribs 180 are formed on the hydrophobic layer 160. The hydrophilic ribs 180 may comprise photoresist, thermosetting resin or photosetting resin. The hydrophilic ribs 180 are isolated from one another and each of them corresponds to a sub-pixel area. A retaining wall 200 is then formed to surround the hydrophilic ribs 180. The retaining wall 200 may comprise photoresist, thermosetting resin or photosetting resin. The retaining wall 200 may have at least one breach (not shown) of about 0.1 mm-5 mm. The retaining wall 200 may have a thickness of about 10 μm-100 μm. Next, a non-polar solution 220 is filled within the hydrophilic ribs 180 by, for example, inkjet printing, dip coating, slide coating, slot coating or blade coating. The non-polar solution 220 may comprise dye or pigment. A polar solution 240 is then formed over the non-polar solution 220 and the hydrophilic ribs 180 within the retaining wall 200 by, for example, inkjet printing, dip coating, slide coating, slot coating or blade coating. The polar solution 240 may comprise water, sodium chloride aqueous solution or potassium chloride aqueous solution. Next, a second substrate 260 is provided. The second substrate 260 may comprise glass, polymer materials or metal. A second electrode 280 is then formed on the second substrate 260. Next, a second retaining wall 320 is formed on the second electrode 280. The second retaining wall 320 may comprise photoresist, thermosetting resin or photosetting resin. The second retaining wall 320 may have at least one breach (not shown) of about 0.1 mm-5 mm. The second retaining wall 320 may have a thickness of about 10 μm-100 μm. A second polar solution 340 is then formed within the second retaining wall 320 by, for example, inkjet printing, dip coating, slide coating, slot coating or blade coating. The second polar solution 340 may comprise water, sodium chloride aqueous solution or potassium chloride aqueous solution. Optionally, the second polar solution 340 is formed within the second retaining wall 320 after the surface of the second substrate 260 is treated. Next, a frame seal 300 is coated on the second electrode 280. The frame seal 300 may have at least one breach (not shown) of about 0.1 mm-5 mm. Optionally, the frame seal 300 is coated on the hydrophobic layer 160 over the first substrate 100, as shown in FIG. 2B. The first substrate 100 and the second substrate 260 are then assembled. After assembling, the frame seal 300 is cured. An electrowetting display 400 is then prepared, as shown in FIG. 2C. In FIG. 2C, the frame seal 300 is adjacent to the second retaining wall 320.

When an electrowetting display is prepared using the method provided by an embodiment of the invention, assembly in water is not required, thus an accurate alignment and large-area production are processed.

While the invention has been described by way of examples and in terms of embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for fabricating an electrowetting display, comprising:
forming a plurality of hydrophilic ribs on a first substrate;
forming a retaining wall surrounding the hydrophilic ribs;
filling a non-polar solution within the hydrophilic ribs;
forming a polar solution over the non-polar solution and the hydrophilic ribs within the retaining wall;
providing a second substrate; and
assembling the first substrate and the second substrate.

2. The method for fabricating an electrowetting display as claimed in claim 1, further comprising forming a hydrophobic layer between the hydrophilic ribs and the first substrate.

3. The method for fabricating an electrowetting display as claimed in claim 2, further comprising forming a dielectric layer between the hydrophobic layer and the first substrate.

4. The method for fabricating an electrowetting display as claimed in claim 3, further comprising forming a first electrode between the dielectric layer and the first substrate.

5. The method for fabricating an electrowetting display as claimed in claim 1, further comprising forming a second electrode on the second substrate.

6. The method for fabricating an electrowetting display as claimed in claim 1, further comprising coating a frame seal with at least one breach on the first substrate or the second substrate.

7. The method for fabricating an electrowetting display as claimed in claim 6, further comprising curing the frame seal after the first and second substrates are assembled.

8. The method for fabricating an electrowetting display as claimed in claim 6, further comprising forming a second retaining wall on the second substrate.

9. The method for fabricating an electrowetting display as claimed in claim 8, further comprising forming a second polar solution within the second retaining wall.

10. The method for fabricating an electrowetting display as claimed in claim 1, wherein the hydrophilic ribs are isolated from one another.

11. The method for fabricating an electrowetting display as claimed in claim 1, wherein each of the hydrophilic ribs corresponds to a sub-pixel area.

12. The method for fabricating an electrowetting display as claimed in claim 1, wherein the hydrophilic rib comprises photoresist, thermosetting resin or photosetting resin.

13. The method for fabricating an electrowetting display as claimed in claim 8, wherein one of the retaining wall and the second retaining wall has at least one breach.

14. The method for fabricating an electrowetting display as claimed in claim 13, wherein the size of the breach is about 0.1 mm-5 mm.

15. The method for fabricating an electrowetting display as claimed in claim 8, wherein the retaining wall and the second retaining wall have a thickness of about 10 μm-100 μm.

16. The method for fabricating an electrowetting display as claimed in claim 8, wherein the retaining wall and the second retaining wall comprise photoresist, thermosetting resin or photosetting resin.

17. The method for fabricating an electrowetting display as claimed in claim 1, wherein the non-polar solution is filled within the hydrophilic ribs by inkjet printing, dip coating, slide coating, slot coating or blade coating.

18. The method for fabricating an electrowetting display as claimed in claim 1, wherein the non-polar solution comprises dye or pigment.

19. The method for fabricating an electrowetting display as claimed in claim 1, wherein the polar solution is formed over the non-polar solution and the hydrophilic ribs by inkjet printing, dip coating, slide coating, slot coating or blade coating.

20. The method for fabricating an electrowetting display as claimed in claim 9, wherein the second polar solution is formed within the second retaining wall by inkjet printing, dip coating, slide coating, slot coating or blade coating.

21. The method for fabricating an electrowetting display as claimed in claim 9, wherein the polar solution or the second polar solution comprise water, sodium chloride aqueous solution or potassium chloride aqueous solution.

22. The method for fabricating an electrowetting display as claimed in claim 9, wherein the second polar solution is formed within the second retaining wall after the surface of the second substrate is treated.

23. The method for fabricating an electrowetting display as claimed in claim 6, wherein the size of the breach of the frame seal is about 0.1 mm-5 mm.

24. The method for fabricating an electrowetting display as claimed in claim 6, wherein the frame seal is adjacent to the retaining wall after the first and second substrates are assembled.

25. The method for fabricating an electrowetting display as claimed in claim 6, wherein the frame seal is on the retaining wall after the first and second substrates are assembled.

26. The method for fabricating an electrowetting display as claimed in claim 8, wherein the frame seal is adjacent to the second retaining wall after the first and second substrates are assembled.
